(19) United States
(12) Patent Application Publication
(10) Pub. No.: US 2011/0191191 A1
(43) Pub. Date: Aug. 4, 2011

(54) PLACEHOLDER BIDS IN ONLINE ADVERTISING

(75) Inventors: Eric Theodore Bax, Pasadena, CA (US); David Reiley, Berkeley, CA (US); Randall Lewis, Santa Clara, CA (US); Tarun Bhatia, Burbank, CA (US); Darshan V. Kantak, Pasadena, CA (US)

(73) Assignee: Yahoo! Inc., Sunnyvale, CA (US)

(21) Appl. No.: 12/697,773

(22) Filed: Feb. 1, 2010

(51) Int. Cl. G06Q 30/00

(52) U.S. Cl. 705/14.71

(57) ABSTRACT

Some embodiments of the invention provide techniques for placing “placeholder” bids in an auction associated with online advertising marketplace. Placeholder bids can include bids that are not actually entered or placed in the auction or marketplace. Rather, placeholder bids can include hypothetical bids. Impacts of placeholder bids, should the placeholder bids have been entered or placed as actual bids, can be assessed. An assessment can include assessing an impact on auction and marketplace parameters, an impact on bid or campaign performance, and an impact on downstream parameters such as user behavior, such as associated conversions or purchasing.

### BACKGROUND

Online advertising may involve marketplaces including auctions in which advertisers place bids, or offers, for serving of their online advertisements in association with available serving opportunities. Advertiser bids may specify targeting or other requirements, as well as a bid amount or amounts. In such an auction-based marketplace, many marketplace parameters are affected by individual advertiser participation and bidding. For instance, advertiser bidding can influence available serving opportunity inventory, pricing, etc. Furthermore, naturally, advertiser bidding affects advertisement serving, and frequency of serving, to users. This, in turn can affect downstream parameters including user behavior such as conversions, purchasing, etc.

Since advertiser bidding has so many important consequences, the effect of particular bids and bidding patterns is important to many parties involved directly or indirectly in the marketplace and auctions. Such parties can include advertisers (including proxies of advertisers), publishers, and third party entities, as well as entities involved in providing or facilitating the marketplace itself. All of these parties may share a significant financial interest in online advertising in connection with the marketplace, which financial interest may be substantially affected by advertiser bidding in the marketplace. Furthermore, a particular advertiser may be interested both in the effect, or potential or predicted effect, of bidding by other advertisers, as well as the effect of a change in a bidding pattern of the particular advertiser itself. Yet, the ability to assess such effects is generally very limited, and even if possible, may require large expenditures, commitment, risk and exposure.

There is a need for techniques for assessing the impact or potential impact of advertiser bidding, including advertiser bidding and bidding patterns in an auction-based online advertising marketplace.

### SUMMARY

Some embodiments of the invention provide techniques for placing placeholder bids in an auction, such as in connection with an online advertising marketplace. Placeholder bids can include bids that are not actually entered or placed in the marketplace. Rather, placeholder bids can include hypothetical bids. One or more impacts of placeholder bids, should the placeholder bids have been placed as actual bids, can be assessed and tracked. Such assessment can include assessing, estimating, calculating, determining or predicting the one or more impacts or effects, or potential, probable, or predicted impacts or effects.

The impacts or effects can include, for example, an impact on the marketplace or elements of the marketplace, an impact on advertisement serving opportunity inventory or availability, an impact on bid performance, and an impact on pricing. The impacts can also include any number of downstream effects of interest, including, for example, an impact on downstream user behavior such as online or offline purchasing, conversions, etc.

Assessments according to embodiments of the invention can be used for many different purposes, including being used in market assessment, being used in determining actual bidding or other advertiser behavior or the behavior of other involved parties, and being used in determining or influencing auction or marketplace parameters, such as, for example, reserve pricing.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention; and

FIG. 4 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

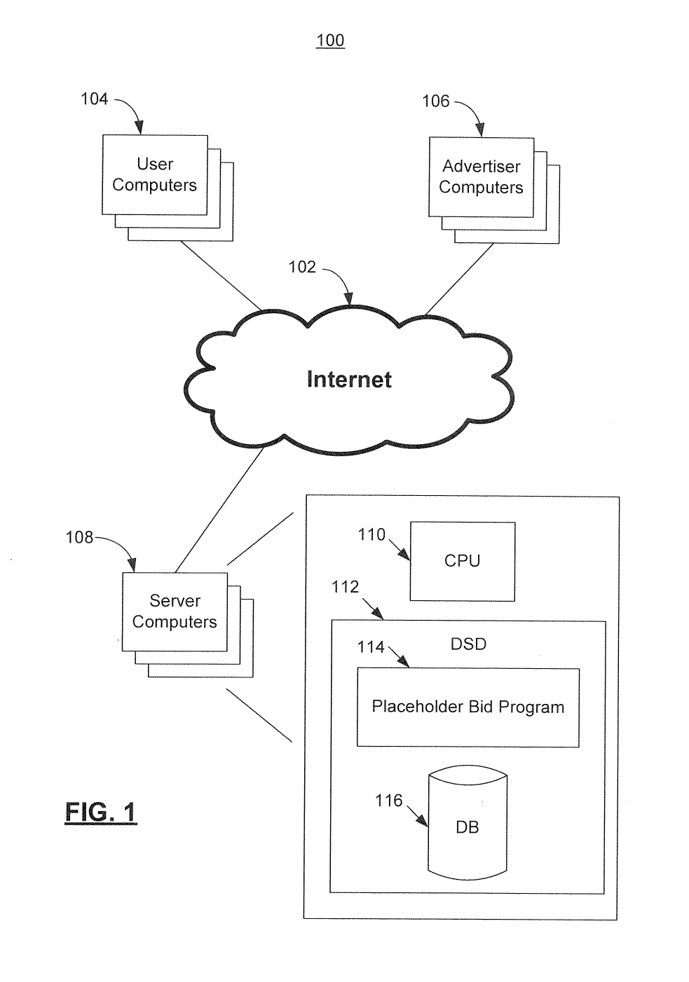

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Placeholder Bid Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

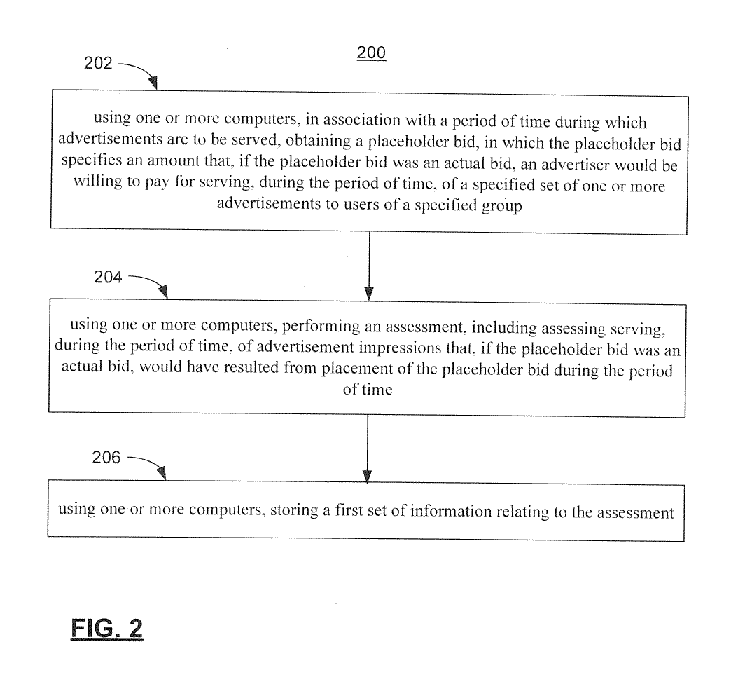

FIG. 2 is a flow diagram of a method 200 according to one embodiment of the invention. At step 202, using one or more computers, in association with a period of time during which advertisements are to be served, a placeholder bid is obtained. The placeholder bid specifies an amount that, if the placeholder bid was an actual bid, an advertiser would be willing to pay for serving, during the period of time, of a specified set of one or more advertisements to users of a specified group. Herein, a specified set of advertisements can broadly includes advertisements of an explicitly or implicitly selected or involved set or type, etc. Furthermore, a specified set of users can broadly include preferred or required types, groups, or profiles of users, preferred or required targeted users, etc.

At step 204, using one or more computers, an assessment is performed. The assessment includes assessing serving, during the period of time, of advertisement impressions that, if the placeholder bid was an actual bid, would have resulted from placement of the placeholder bid during the period of time.

At step 206, using one or more computers, a first set of information is stored relating to the assessment.

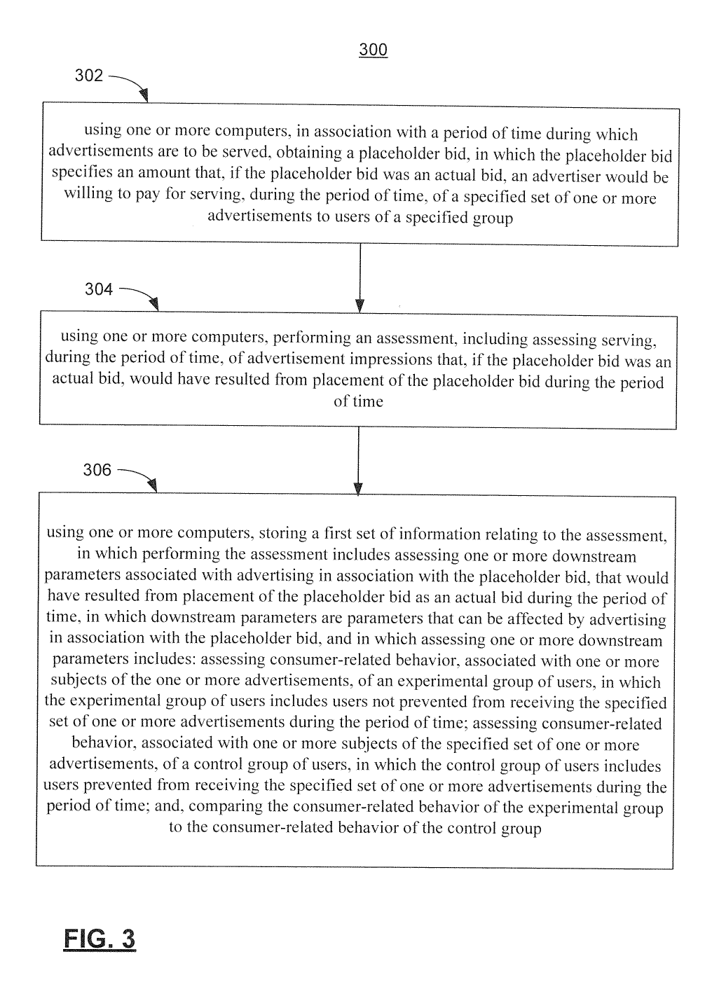

FIG. 3 is a flow diagram illustrating a method 300 according to one embodiment of the invention. Steps 302 and 304 are similar to steps 202 and 204 as depicted in FIG. 2.

At step 306, using one or more computers, a first set of information is stored relating to the assessment. Performing the assessment includes assessing one or more downstream parameters associated with advertising in association with the placeholder bid, which would have resulted from placement of the placeholder bid as an actual bid during the period of time. Downstream parameters are parameters that can be affected by advertising in association with the placeholder bid. Downstream parameters need not be limited to online parameters, and can include, for instance, offline or physical store purchases, etc. As such, embodiments of the invention contemplate integration and communication between online and offline entities including stores, etc.

Assessing one or more downstream parameters includes assessing consumer-related behavior, associated with one or more subjects of the one or more advertisements, of an experimental group of users. The experimental group of users includes users not prevented from receiving the one or more advertisements during the period of time. Assessing one or more downstream parameters further includes assessing consumer-related behavior, associated with one or more subjects of the one or more advertisements, of a control group of users. The control group of users includes users prevented from receiving the one or more advertisements during the period of time. Assessing one or more downstream parameters further includes comparing the consumer-related behavior of the experimental group to the consumer-related behavior of the control group.

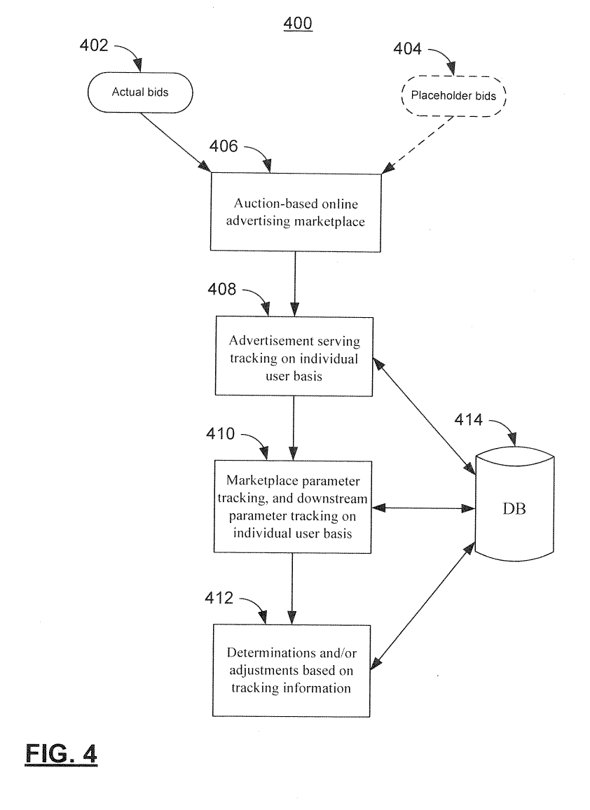

FIG. 4 is a block diagram 400 illustrating one embodiment of the invention. Blocks 402 and 404 represent actual and placeholder bids, or offers, respectively. An online advertising marketplace is represented by block 406.

The placeholder bid block 404 is depicted in a broken line, to indicate that the bids are not actually entered or placed in the marketplace, and therefore do not actually affect auction, marketplace or downstream parameters, including not affecting advertiser bidding, pricing, inventory availability, or other campaign parameters. However, serving as well as affects or impacts of the placeholder bids, or predicted, likely, approximately, estimated, forecasted or probable serving and affects or impacts, may be determined and tracked.

Block 408 represents advertisement serving tracking, which may be done on an individual user basis. Tracking information may be stored, such as in database 414.

Block 410 represents marketplace parameter tracking, and downstream parameter tracking on individual user basis. Tracking information may be stored, such as the database 414. Marketplace parameters are intended to broadly include any of various parameters or aspects of the marketplace as a whole, or any of its elements or aspects, or associated elements or aspects, including, for example, auction parameters and advertiser and advertiser campaign parameters.

Block 412 represents determinations and/or adjustments based on tracking information, such as tracking information as described in connection with blocks 406, 408 and 410. Information relating to such determinations and/or adjustments may be stored, such as in the database 414. Such determinations or adjustments can include, for example, determinations, adjustments, balancing, improvement, or optimization of marketplace parameters, including auction or advertising campaign parameters.

Some embodiments of the invention are associated with an auction-based online advertising marketplace. In such marketplaces, advertisers (including proxies thereof) place bids, or offers, in connection with advertisements they wish to have served as part of online advertising campaigns. Such marketplaces can relate to graphical or banner advertising, keyword-associated, sponsored search advertising, etc.

Typically, a bid includes an amount an advertiser is willing to pay for serving of an advertisement, or an impression. The bid may, explicitly or implicitly, include many specific restrictions, requirements, etc. For instance, a particular bid may be for serving of a particular advertisement, or a specific type of advertisement or advertisement from a particular group, at some point during a particular period of time. The bid often also includes targeting parameters, preferences, or requirements. Targeting requirements may relate to any of various aspects of the advertising context, including specifying a preferred or required user set or group. For instance, a bid may specify that a particular advertisement is to be served only to users of a particular demographic group, users in a particular location (geotargeting), etc. Of course, many other types of targeting may also be employed. In sponsored search advertising, a bid, or an associated amount, may also determine, partially determine or be associated with, a particular type of placement, such as a rank, or level of prominence relating to the displayed advertisement. Furthermore, agreements or contracts are often utilized between an advertiser and an entity associated with facilitating serving of advertisements. Such agreements or contracts, as known in the art, can include minimum performance requirements, etc.

In an auction-based marketplace, in which many advertisers participate, each advertiser's bidding, including cumulative bidding and bidding patterns, can affect the auction and marketplace, as well as other advertisers. For example, a particular advertiser's bidding can affect serving opportunity inventory and availability for all or many advertisers, or may cause pricing changes that affect all or many advertisers. Many other examples are possible, of course.

Placeholder bids, as described herein, including associated tracking (including tracking of serving and marketplace or advertiser or advertisement campaign parameters, including downstream parameters, can be used by many different entities, in different ways, and for different purposes. For instance, a particular advertiser may be interested in how a particular bidding strategy would affect (or might affect) marketplace parameters such as pricing and inventory availability. A particular advertiser might also be interested in the effect of different bidding strategies on downstream parameters associated with the advertising campaign, such as downstream user behavior including conversions or purchases, for example. Actually implementing such strategies, however, might be impractical, expensive, etc. Utilizing placeholder bids and associated tracking, however, may be very practical and informative, and can be used to help guide future conduct. Placeholder bids might also be utilized, for example, by an entity associated with facilitating or operating the auction or marketplace, in assessing marketplace conditions or health, or in marketplace monitoring, balancing, optimization, and implementation of balancing or fairness measures. Placeholder bidding and associated tracking information can be used, for example, to assess the effect and effectiveness of proposed actual offers, including how much inventory they would win, or might win, and how the bids would affect other prices and amounts of inventory won by other bids, etc. The information also supports running controlled experiments, such as experiments run to provide advertisers with proof of the return on investment from running advertisements, for example.

In some embodiments, advertisers or other entities can use placeholder bids to assess the potential effect of particular bidding strategies on marketplace conditions and availability of particular inventory at various pricing. In some embodiments, placeholder bids can be hypothetically entered or placed alongside or with actual bids. However, since the placeholder bids are not placed as actual bids, they do not affect actual marketplace conditions, they cannot win auctions, etc. Instead, the marketplace records or facilitates recording or tracking of how the placeholder bids would perform if they were actual offers, and how the marketplace and elements thereof would be affected. Downstream parameters can also be monitored and tracked.

In some embodiments, placeholder bids can be used in performing controlled experiments. Such experiments could be used for a variety of purposes and by various entities, such as a marketplace facilitator or advertisers. For example, controlled experiments can be used in assessing or measuring the value, whether online, offline or both, of impressions to advertisers. Generally, such experiments can be used for purposes including assessing causality between advertisement serving and exposure and marketplace conditions or user behavior.

In some embodiments, placeholder bidding or tracking could be used in performing a controlled experiment that can include determining or identifying a control group of users and an experimental group of users.

The control group users could be prevented from being serving a particular advertisement (or an advertisement of a particular type, etc.). However, the marketplace could track the frequency with which, or amount of times during a period that, each of the control group users would have received the particular advertisement, had each not been prevented from receiving them. This tracking could include determining or predicting how many times each of the control group users would or might have been served an advertisement during a particular pertinent period of time. This frequency or other measure could be affected by factors including targeting criteria, which could include user targeting criteria associated with bids associated with the particular advertisement.

The experimental users, by contrast, would not be prevented from being served the advertisement, and could actually be served the advertisement. Tracking could be performed of each of their frequency of exposure or amount of exposures.

Follow the period of serving of the advertisement, monitoring and tracking could be performed of downstream parameters associated or potentially associated with the particular advertisement. Such downstream parameters could include a variety of information, including downstream user behavior for each of a group of users including control group users and experimental group users. For example, tracked downstream parameters could include conversions, purchases, etc., and could include both online and offline behavior tracking. For example, if the particular advertisement relates to Store A (or an online store, etc.), then tracked user behavior could include user visits or purchases at Store A during a period of time following the advertisement serving period, for example.

With this tracked information, relevant behavior, such as conversion behavior, of control group users could be compared with behavior of experimental group users. Furthermore, users in each group could be divided or subdivided based on, for example, frequency or amount of actual or hypothetical exposure to the particular advertisement. For example, behavior of users in the control group who would have or might have been served the particular advertisement a certain number of times, for example 20-30 times, during the period, could be directly compared with behavior of experimental group users who actually received the advertisement 20-30 times during the period. This type of “apples to apples” comparison can help provide a very accurate and granular way to assess how effective an advertisement is on influencing relevant behavior of particular groups of users. Of course, this is merely one example of a type of controlled experiment and a user thereof and many others are practical and contemplated.

In some embodiments, placeholder bids and tracking can be used in marketplace monitoring, analysis, and administration, which can include policing, balancing, optimization, or ensuring marketplace fairness.

For example, in some situations, particular advertisers access to more or better information than other advertisers with regard to how advertisements, impressions or particular serving opportunities will or are likely to perform, which can lead to an unfair or unreasonable bidding advantage. For instance, in some advertising exchanges, some advertisers may be able to collect or obtain more or better advertisement or serving opportunity performance information than other advertisers, which can lead to an unfair situation.

The following example is simplified and extreme, but serves to demonstrate how placeholder bidding and tracking can be used to provide a remedy to such an unfair situation. Suppose that a group of “normal” advertisers, having normal information access regarding serving opportunities (which can include equivalents thereof), bid one cent per impression, believing that one in one hundred impressions will obtain a click, so that the anticipated per-click cost is one dollar. Suppose also that a “privileged” advertiser, who is particular unfairly or unreasonably well-informed, knows exactly which of one hundred impressions will actually obtain a click. The privileged advertiser might bid two cents for that particular impression or serving opportunity, knowing that he or she will outbid the normal advertisers but still only pay two cents for a click.

This can be a very undesirable and unfair situation, to the normal advertisers, to the involved publisher, and to the marketplace as a whole, as well as marketplace facilitator or provider entities. The normal advertisers soon realize that they are obtaining no clicks, and stop participating, leaving the privileged advertiser to buy only, for two cents, the one in one hundred impressions that will lead to a conversion. The other ninety-nine impressions go unpurchased. The publisher is left with only the one impression of the one hundred purchased for two cents, instead of having each of the one hundred impressions purchased for one cent. As a result of all this, the normal advertisers do poorly, the publisher does poorly, the marketplace provider or facilitator does poorly, and the marketplace as a whole suffers.

Placeholder bidding and tracking can be used in preventing or remedying such a problematic situation. For example, in some embodiments, placeholder bidding and tracking can be used to assess ahead of time how privileged advertiser type bidding patterns would affect conditions. This could include, for example, running such bidding patterns as placeholder bids before actually placing associated bidding in the marketplace. Such placeholder bidding and tracking could be used to assess how and to what degree pricing and advertisement performance would or might be negatively affected by particular privileged advertiser bidding or bidding patterns. This information could be used to inform, determine or help determine a remedy. For instance, in some embodiments, based on the placeholder bidding and tracking information, reserve pricing can be determined to remove or mitigate the unreasonableness, unfairness, or suboptimal marketplace performance that would otherwise be caused by the bidding of the privileged advertiser. For example, in the foregoing hypothetical, the privileged advertiser's bidding could be assessed before being implemented, and a reserve price could be applied to the privileged advertiser. For instance, a reserve price of one dollar per impression could be imposed, which would remove the unfair advantage of the privileged advertiser. Of course, many other uses of placeholder bidding and tracking are practical and contemplated.

While the invention is described with reference to the above drawings, the drawings are intended to be illustrative, and the invention contemplates other embodiments within the spirit of the invention.

1. A method for use in association with an online advertising auction relating to an online advertising marketplace, the method comprising:
using one or more computers, in association with a period of time during which advertisements are to be served, obtaining a placeholder bid;
wherein the placeholder bid specifies an amount that, if the placeholder bid was an actual bid, an advertiser would be willing to pay for serving, during the period of time, of a specified set of one or more advertisements to users of a specified group;
using one or more computers, performing an assessment, comprising assessing serving, during the period of time, of advertisement impressions that, if the placeholder bid was an actual bid, would have resulted from placement of the placeholder bid during the period of time; and
using one or more computers, storing a first set of information relating to the assessment.

2. The method of claim 1, wherein performing the assessment comprises assessing an impact on one or more parameters, associated with the auction or the marketplace, that, if the placeholder bid was an actual bid, would have resulted from placement of the placeholder bid during the period of time.

3. The method of claim 1, wherein performing the assessment comprises assessing an impact on one or more parameters, associated with the auction or the marketplace, that, if the placeholder bid was an actual bid, would have resulted from placement of the placeholder bid during the period of time, wherein assessing the impact comprises determining a difference in the one or more parameters that would have resulted from placement of the placeholder bid as an actual bid as compared to non-placement of the placeholder bid as an actual bid.

4. The method of claim 1, wherein performing the assessment comprises assessing an impact on one or more parameters, associated with the auction or the marketplace, that, if the placeholder bid was an actual bid, would have resulted from placement of the placeholder bid during the period of time, comprising assessing an impact on auction-associated advertising inventory.

5. The method of claim 1, wherein performing the assessment comprises assessing an impact on one or more parameters, associated with the auction or the marketplace, that, if the placeholder bid was an actual bid, would have resulted from placement of the placeholder bid during the period of time, comprising assessing an impact on auction-associated serving opportunity inventory.

6. The method of claim 1, wherein performing the assessment comprises assessing an impact on one or more parameters, associated with the auction or the marketplace, that, if the placeholder bid was an actual bid, would have resulted from placement of the placeholder bid during the period of time, comprising assessing an impact on auction-associated pricing.

7. The method of claim 1, wherein performing the assessment comprises assessing one or more downstream parameters associated with advertising in association with the placeholder bid, that would have resulted from placement of the placeholder bid as an actual bid during the period of time, and wherein downstream parameters are parameters measured after the period of time but that can be affected by advertising during the period of time.

8. The method of claim 1, wherein performing the assessment comprises assessing one or more downstream parameters associated with advertising in association with the placeholder bid, that would have resulted from placement of the placeholder bid as an actual bid during the period of time, wherein downstream parameters are parameters that can be affected by advertising in association with the placeholder bid, and wherein the one or more downstream parameters comprise consumer conversions associated with one or more subjects of the one or more advertisements.

9. The method of claim 1:
wherein performing the assessment comprises:
assessing one or more downstream parameters associated with advertising in association with the placeholder bid, that would have resulted from placement of the placeholder bid as an actual bid during the period of time, wherein downstream parameters are parameters that can be affected by advertising in association with the placeholder bid;
and wherein assessing one or more downstream parameters comprises:
assessing consumer-related behavior, associated with one or more subjects of the one or more advertisements, of an experimental group of users, wherein the experimental group of users comprises users not prevented from receiving the one or more advertisements during the period of time;
assessing consumer-related behavior, associated with one or more subjects of the one or more advertisements, of a control group of users, wherein the control group of users comprises users prevented from receiving the specified set of one or more advertisements during the period of time; and
comparing the consumer-related behavior of the experimental group to the consumer-related behavior of the control group.

10. The method of claim 9, wherein the one or more subjects comprise one or more products, services, or content items advertised by the one or more advertisements.

11. The method of claim 9, comprising:
dividing users, of the experimental group of users, into categories based on frequency of serving of the specified set of one or more advertisements to each user during the period of time, and
dividing users, of the control group of users, into categories based on frequency of serving of the specified set of one or more advertisements to each user during the period of time, which would have occurred if the control group of users had not been prevented from receiving the specified set of one or more advertisements during the period of time;
and wherein performing the assessment comprises comparing downstream behavior of users in like categories from the control group of users and the experimental group of users.

12. The method of claim 9, comprising assessing an impact on conversions that would have occurred if the placeholder bid had been placed as an actual bid during the period of time.

13. The method of claim 9, comprising assessing an impact on purchasing that would have occurred if the placeholder bid had been placed as an actual bid during the period of time.

14. The method of claim 9, comprising assessing an impact on offline purchasing that would have occurred if the placeholder bid had been placed as an actual bid during the period of time.

15. The method of claim 9, comprising assessing an impact on advertiser profit that would have occurred if the placeholder bid had been placed as an actual bid during the period of time.

16. The method of claim 9, comprising utilizing the assessment in determining reserve pricing for one or more advertisers.

17. A system for use in association with an online advertising auction relating to an online advertising marketplace, the system comprising:
one or more server computers coupled to a network; and
one or more databases coupled to the one or more servers;
wherein the one or more server computers are for:
in association with a period of time during which advertisements are to be served, obtaining a placeholder bid;
wherein the placeholder bid specifies an amount that, if the placeholder bid was an actual bid, an advertiser would be willing to pay for serving, during the period of time, of a specified set of one or more advertisements to users of a specified group;
performing an assessment, comprising assessing serving, during the period of time, of advertisement impressions that, if the placeholder bid was an actual bid, would have resulted from placement of the placeholder bid during the period of time; and
storing a first set of information relating to the assessment.

18. The system of claim 17, wherein performing the assessment comprises assessing an impact on one or more parameters, associated with the auction or the marketplace, that, if the placeholder bid was an actual bid, would have resulted from placement of the placeholder bid during the period of time.

19. The system of claim 17, wherein performing the assessment comprises assessing one or more downstream parameters associated with advertising in association with the placeholder bid, that would have resulted from placement of the placeholder bid as an actual bid during the period of time, and wherein downstream parameters are parameters measured after the period of time but that can be affected by advertising during the period of time.

20. A computer readable medium or media containing instructions for executing a method for use in association with an online advertising auction relating to an online advertising marketplace, the method comprising:
using one or more computers, in association with a period of time during which advertisements are to be served, obtaining a placeholder bid;
wherein the placeholder bid specifies an amount that, if the placeholder bid was an actual bid, an advertiser would be willing to pay for serving, during the period of time, of a specified set of one or more advertisements to users of a specified group;
using one or more computers, performing an assessment, comprising assessing serving, during the period of time, of advertisement impressions that, if the placeholder bid was an actual bid, would have resulted from placement of the placeholder bid during the period of time; and
using one or more computers, storing a first set of information relating to the assessment;
wherein performing the assessment comprises:
assessing one or more downstream parameters associated with advertising in association with the placeholder bid, that would have resulted from placement of the placeholder bid as an actual bid during the period of time, wherein downstream parameters are parameters that can be affected by advertising in association with the placeholder bid;
and wherein assessing one or more downstream parameters comprises:
assessing consumer-related behavior, associated with one or more subjects of the one or more advertisements, of an experimental group of users, wherein the experimental group of users comprises users not prevented from receiving the specified set of one or more advertisements during the period of time;
assessing consumer-related behavior, associated with one or more subjects of the one or more advertisements, of a control group of users, wherein the control group of users comprises users prevented from receiving the specified set of one or more advertisements during the period of time; and
comparing the consumer-related behavior of the experimental group to the consumer-related behavior of the control group.
